(19) United States
(12) Patent Application Publication
(10) Pub. No.: US 2025/0371777 A1
(43) Pub. Date: Dec. 4, 2025

(54) ANIMATION GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Guangming YAO, Beijing (CN); Zhurong XIA, Beijing (CN)

(21) Appl. No.: 19/224,246

(22) Filed: May 30, 2025

(30) Foreign Application Priority Data
May 30, 2024 (CN) 202410693285.5

(51) Int. Cl. G06T 13/20; G06T 13/40; G10L 15/02

(52) U.S. Cl. CPC G06T 13/205; G06T 13/40; G10L 15/02

(57) ABSTRACT

An animation generation method and apparatus, an electronic device, and a storage medium. The method includes: obtaining at least one control condition determined based on at least one speech feature subsequence and a facial expression style feature; generating, by using a preset decoder, a target blendshape parameter corresponding to the at least one speech feature subsequence based on the at least one control condition and at least one preset variable, where the preset decoder is included in a preset generation model constructed based on at least one sample control condition and at least one second blendshape parameter sequence, and the at least one second blendshape parameter sequence is related to semantics of sample speech data corresponding to the at least one sample control condition; and deforming an object model based on at least one target blendshape parameter in sequence to generate a facial animation corresponding to speech data.

### CROSS-REFERENCE TO RELATED APPLICATION

The present application claims priority to Chinese Patent Application No. 202410693285.5, filed on May 30, 2024, and the disclosure of the above Chinese patent application is incorporated herein by reference in its entirety as part of the present application.

### TECHNICAL FIELD

Embodiments of the present disclosure relate to the field of computer technologies, and in particular, to an animation generation method and apparatus, an electronic device, and a storage medium.

### BACKGROUND

Currently, the technology for generating a lip sync animation corresponding to speech data has been widely applied in various fields. In the prior art, animations are often generated in a vertex-driven manner.

### SUMMARY

Embodiments of the present disclosure provide an animation generation method and apparatus, an electronic device, and a storage medium, which can implement animation generation based on blendshape parameters.

According to a first aspect, an embodiment of the present disclosure provides an animation generation method, including:
obtaining at least one control condition determined based on each of at least one speech feature subsequence and a facial expression style feature, where the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
generating, by using a preset decoder, a target blendshape parameter corresponding to the at least one speech feature subsequence based on the at least one control condition and at least one preset variable, where the preset decoder is included in a preset generation model, the preset generation model is constructed based on at least one sample control condition and at least one second blendshape parameter sequence, and the at least one second blendshape parameter sequence is related to semantics of sample speech data corresponding to the at least one sample control condition; and
deforming an object model based on at least one target blendshape parameter in sequence to generate a facial animation corresponding to the speech data.

According to a second aspect, an embodiment of the present disclosure further provides an animation generation apparatus, including:
an obtaining module, configured to obtain at least one control condition determined based on each of at least one speech feature subsequence and a facial expression style feature, where the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
a parameter sequence generation module, configured to generate, by using a preset decoder, a target blendshape parameter corresponding to the at least one speech feature subsequence based on the at least one control condition and at least one preset variable, where the preset decoder is included in a preset generation model, the preset generation model is constructed based on at least one sample control condition and at least one second blendshape parameter sequence, and the at least one second blendshape parameter sequence is related to semantics of sample speech data corresponding to the at least one sample control condition; and
an animation generation module, configured to deform an object model based on at least one target blendshape parameter in sequence to generate a facial animation corresponding to the speech data.

According to a third aspect, an embodiment of the present disclosure further provides an electronic device. The electronic device includes:
one or more processors; and
a storage apparatus configured to store one or more programs,
where the one or more programs, when executed by the one or more processors, cause the one or more processors to implement the animation generation method according to any one of the embodiments of the present disclosure.

According to a fourth aspect, an embodiment of the present disclosure further provides a non-transitory computer-readable storage medium containing computer-executable instructions that, when executed by a computer processor, are configured to cause the computer processor to perform the animation generation method according to any one of the embodiments of the present disclosure.

### BRIEF DESCRIPTION OF DRAWINGS

The foregoing and other features, advantages, and aspects of embodiments of the present disclosure will become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an animation generation method according to an embodiment of the present disclosure;

FIG. 2 is a schematic block diagram of a data flow of an animation generation method according to an embodiment of the present disclosure;

FIG. 3 is a schematic diagram of a speech feature subsequence and a third blendshape parameter sequence in an animation generation method according to an embodiment of the present disclosure;

FIG. 4 is a schematic flowchart of constructing a preset generation model in an animation generation method according to an embodiment of the present disclosure;

FIG. 5 is a schematic block diagram of a data flow of constructing a preset generation model in an animation generation method according to an embodiment of the present disclosure;

FIG. 6 is a schematic diagram of a structure of an animation generation apparatus according to an embodiment of the present disclosure; and

FIG. 7 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “comprise/include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

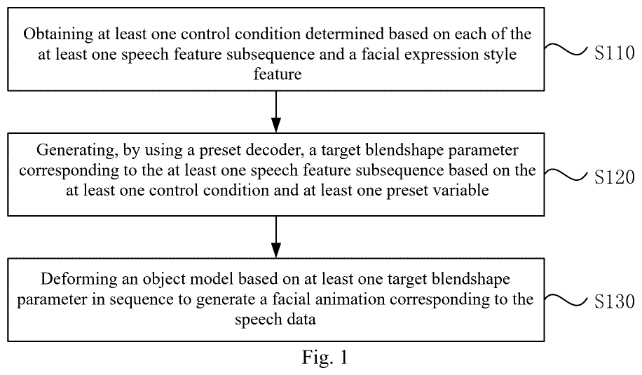

FIG. 1 is a schematic flowchart of an animation generation method according to an embodiment of the present disclosure. This embodiment of the present disclosure is applicable to scenarios where a lip sync animation corresponding to speech data is generated. The method may be performed by an animation generation apparatus. The apparatus may be implemented in the form of software and/or hardware, and may be configured in an electronic device, for example, in a mobile phone or a computer.

As shown in FIG. 1, the animation generation method provided in this embodiment may include the following steps.

S110: obtaining at least one control condition determined based on at least one speech feature subsequence and a facial expression style feature.

In this embodiment of the present disclosure, the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data.

The speech data may include speech data of any duration. Speech data input by a user may be acquired in real time through an audio acquisition module, or previously recorded speech data may be read from a preset storage space, or the like. For speech data A, corresponding speech features F_{A}∈R^{T,M} may be obtained through an existing feature extractor, where T may represent a number of speech features corresponding to speech data per second, for example, T may be 25, and M may represent a dimension of each speech feature.

In this embodiment of the present disclosure, a corresponding target blendshape parameter may be generated for each speech feature in the speech feature sequence. During the process of pronunciation, there may be liaison, and the target blendshape parameter corresponding to a current speech feature may be influenced by the preceding and following speech features. In this embodiment, a group of speech feature subsequences centered around the current speech feature and including a plurality of corresponding preceding and following speech features may be obtained in a sliding window grouping manner, to jointly generate the target blendshape parameter corresponding to the current speech feature. Thus, lip movements in the facial animation can be close to lip movements in a real liaison situation, which allows the generated animation to be more precise and natural.

In the related art, a blendshape (BS) deformer may be used to deform a base shape into a target shape by applying different morph targets (also referred to as shape keys) to the base shape. For example, the base shape may be a face with no expression, and the morph targets may include a face with raised eyebrows, a face with an open jaw, a face with closed eyes, a face with upturned corners of the mouth, and the like. The morph targets applied to the base shape may have intensity coefficients, so that an interpolation operation is performed between the morph targets and the base shape based on the intensity coefficients to obtain the target shape. In this embodiment of the present disclosure, a set of intensity coefficients of the morph targets applied to the base shape may constitute a blendshape parameter. For example, the blendshape parameter may include 51-dimensional intensity coefficients. The blendshape parameter may be applied to any two-dimensional object model or three-dimensional object model that has been defined with blendshape deformers.

In this embodiment, the blendshape parameter sequence may include a sequence composed of a plurality of blendshape parameters. The first blendshape parameter sequence being unrelated to semantics of the speech data may be understood as that the lip movement changes in the animation generated based on the first blendshape parameter sequence do not correspond to the lip movement changes corresponding to the speech data. In other words, the animation generated based on the first blendshape parameter sequence does not express the semantics corresponding to the speech data. The length of the first blendshape parameter sequence may be adjusted based on the actual application effects. For example, the length of the first blendshape parameter sequence may be a blendshape parameter length corresponding to speech data of three seconds. By obtaining the first blendshape parameter sequence that is unrelated to the semantics of the speech data, the decoupling of the speech data from facial expressions can be achieved, which is conducive to the implementation of diversified animation generation.

It can be understood that although the first blendshape parameter sequence is unrelated to the semantics of the speech data, the first blendshape parameter sequence may be related to an object subjected to speech data acquisition. For example, assuming that speech data A and speech data B of a user A have been acquired. The speech data A may be used as the speech data in this embodiment, and a blendshape parameter sequence corresponding to the speech data B may be used as the first blendshape parameter sequence. In this way, the generated target blendshape parameters may not only correspond to the speech data but also maintain the facial expressions of the user A, thus achieving a consistent presentation effect that both the speech and the facial expressions in the animation belong to the user A. In this case, the blendshape parameter sequence corresponding to another segment of speech data from the same object subjected to speech data acquisition may be used as the first blendshape parameter sequence.

In addition, the first blendshape parameter sequence may also be unrelated to the object subjected to speech data acquisition. For example, assuming that speech data A of a user A and speech data B of a user B have been acquired. The speech data A may be used as the speech data in this embodiment, and a blendshape parameter sequence corresponding to the speech data B of the user B may be used as the first blendshape parameter sequence. In this way, the generated target blendshape parameters may correspond to the speech data while imitating the facial expressions of the user B, thus achieving a diversified presentation effect that the speech in the animation belongs to the user A and the facial expressions in the animation belong to the user B. In this case, the blendshape parameter sequence corresponding to another segment of speech data from an object different from the object subjected to speech data acquisition may be used as the first blendshape parameter sequence.

In this embodiment, speech data of different objects may be acquired in advance, and the corresponding first blendshape parameter sequences may be determined based on the acquired speech data and then stored. Accordingly, based on the user's selection operation, a desired first blendshape parameter sequence may be selected from the pre-stored first blendshape parameter sequences.

In this embodiment, the facial expression style feature may represent the facial presentation manners such as expressions and lip movements of the object model when speaking. Feature extraction may be performed on the first blendshape parameter sequence based on an existing sequence feature extraction manner, and an obtained feature vector may be used as the facial expression style feature.

In this embodiment of the present disclosure, each group of speech feature sequences corresponding to the speech data may be concatenated with the facial expression style feature to obtain the control conditions. In some implementations, a determination process of the at least one control condition may include: processing, by using a preset processing algorithm, the at least one speech feature subsequence into a target feature sequence with a preset dimension and a preset size; and concatenating the at least one target feature sequence with the facial expression style feature, respectively, to obtain the at least one control condition.

The dimension and/or size of the speech feature subsequence is larger compared with that of the facial expression style feature. In the control condition obtained by directly concatenating these two, the facial expression style feature occupies a smaller proportion of information, which leads to a significant deviation between the generated animation and a style corresponding to the facial expression style feature when the object model is driven based on the target blendshape parameters generated accordingly. In these optional implementations, a preset processing algorithm, such as a feature compression algorithm, may be used to process each group of speech feature subsequences into a target feature sequence with preset dimensions and sizes. The preset dimensions and sizes are preset based on the actual application scenario. After the target feature sequences are determined, each of the target feature sequences may be concatenated with the facial expression style feature to obtain the control conditions, thereby ensuring that when the object model is driven based on the target blendshape parameters generated accordingly, the generated animation is not only consistent with the speech but also meets the desired style, thereby improving the animation generation effect.

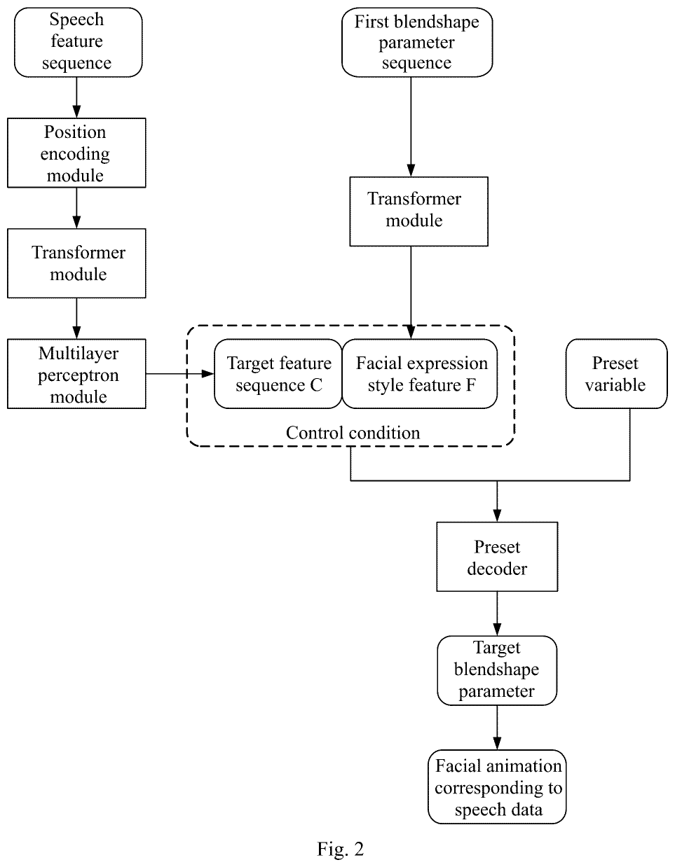

For example, FIG. 2 is a schematic block diagram of a data flow of an animation generation method according to an embodiment of the present disclosure. Referring to FIG. 2, each group of speech feature subsequences may be processed through a position encoding module, a transformer module, and a multilayer perceptron (MLP) module to process each group of speech feature sequences into a target feature sequence C with preset dimensions and sizes. Moreover, a facial expression style feature F may be obtained by performing feature extraction on the first blendshape parameter sequence through the transformer module. The control condition corresponding to each group of speech feature subsequences may be obtained by concatenating C and F.

S120: Generating, by using a preset decoder, a target blendshape parameter corresponding to the at least one speech feature subsequence based on the at least one control condition and at least one preset variable.

In this embodiment of the present disclosure, the preset decoder is included in the preset generation model, the preset generation model is constructed based on at least one sample control condition and at least one second blendshape parameter sequence, and the at least one second blendshape parameter sequence is related to semantics of sample speech data corresponding to the at least one sample control condition.

In this embodiment, the at least one sample control condition is applied in the process of constructing the preset generation model, is essentially the same as the control condition and may be composed of at least one sample speech feature subsequence and the sample facial expression style feature. The at least one sample speech feature subsequence may be obtained by extracting a sample speech feature sequence of the sample speech data based on a sliding window. The sample facial expression style feature may be unrelated to the semantics of the sample speech data.

During the process of constructing the preset generation model, at least one second blendshape parameter sequence is also used. The at least one second blendshape parameter sequence is related to the semantics of the sample speech data corresponding to the at least one sample control condition. It can be understood as that, based on the at least one second blendshape parameter sequence, at least one blendshape parameter may be generated. Based on the at least one blendshape parameter, the lip movement changes in the animation are generated, which are consistent with the lip movement changes of the sample speech data corresponding to the at least one sample control condition.

During the process of acquiring sample speech data, the user's facial shape may be acquired in real time, and at least one second blendshape parameter sequence may be determined based on the acquired facial shape. Alternatively, at least one second blendshape parameter sequence may also be obtained through other manners, such as manually adjusting vertices of the model, which is not exhaustive herein. The acquisition of the sample speech data and the facial shapes shall comply with the requirements of corresponding laws, regulations, and relevant provisions.

By constructing the preset generation model based on the at least one sample control condition and the at least one second blendshape parameter sequence, the preset generation model has the capabilities to predict variables in a latent space based on the control conditions and the second blendshape parameter sequence, and the capabilities to reconstruct the second blendshape parameter sequence based on the control conditions and the predicted variables. The prediction capability may be implemented based on a preset encoder of the preset generation model, and the reconstruction capability may be implemented based on the preset decoder. The latent space may be understood as a feature space constructed based on the preset encoder. The predicted variables belong to the latent space.

Accordingly, referring again to FIG. 2, during the process of animation generation, the reconstruction capability of the preset decoder in the preset generation model may be used to generate the target blendshape parameters corresponding to each group of speech feature sequences based on the at least one control condition and the at least one preset variable. A determination process of the at least one preset variable may include: performing at least one sampling process in the latent space constructed by the preset encoder to obtain at least one preset variable, where the preset encoder is included in the preset generation model. The sampling process, may be, for example, a random sampling process, etc.

S130: Deforming an object model based on at least one target blendshape parameter in sequence to generate a facial animation corresponding to the speech data.

In this embodiment of the present disclosure, the object model is a model to be driven that has been defined with blendshape deformers. The object model includes at least one of the following: a two-dimensional object model and a three-dimensional object model. The two-dimensional object model may include a real facial model and a simulated facial model; and the three-dimensional object model may be a pre-constructed three-dimensional head model. The object model may include a model that has an appearance similar with that of the object subjected to speech data acquisition, or include a model of any appearance determined from a plurality of preset models based on a model selection operation input by the user. Based on an existing object model generation manner, an object model having an appearance similar with that of the object subjected to speech data acquisition may be generated based on the appearance.

In this embodiment of the present disclosure, the object model may be driven based on the target blendshape parameters. The speech data has temporality, and the correspondingly generated speech feature subsequence also has temporality. Since there is a correspondence between each target blendshape parameter and each speech feature subsequence, each blendshape parameter also has temporality. On this basis, the object model may be deformed based on the target blendshape parameters in sequence. Thus, it is possible to drive the object model based on the speech data to generate the facial animation, and the object model in the facial animation can present lip movement changes consistent with the speech. For example, when the speech data is “Hello”, the object model in the output facial animation can present the corresponding lip movement changes for “Hello”.

According to the technical solutions of the embodiments of the present disclosure, the at least one control condition determined based on the at least one speech feature subsequence and the facial expression style feature is obtained, where the at least one speech feature subsequence is obtained by extracting the speech feature sequence of the speech data based on the sliding window, the facial expression style feature is obtained by performing feature extraction on a first blendshape parameter sequence, and the first blendshape parameter sequence is unrelated to the semantics of the speech data; the target blendshape parameter corresponding to the at least one speech feature subsequence is generated by using the preset decoder based on the at least one control condition and the at least one preset variable, where the preset decoder is included in the preset generation model, the preset generation model is constructed based on the at least one sample control condition and the at least one second blendshape parameter sequence, and the at least one second blendshape parameter sequence is related to the semantics of sample speech data corresponding to the at least one sample control condition; and the object model is deformed based on at least one target blendshape parameter in sequence to generate the facial animation corresponding to speech data.

By extracting the at least one speech feature subsequence from the speech feature sequence of the speech data based on the sliding window, and combining each speech feature subsequence with the facial expression style feature to form the control conditions, the preset decoder can control the generation of the target blendshape parameters from preset variables based on the control conditions. The generated target blendshape parameters correspond to the speech feature subsequences, thereby driving the object model based on the target blendshape parameters in sequence, so that the object model in the generated facial animation can achieve the effect that lip movement changes are consistent with the speech. Moreover, since the target blendshape parameter corresponding to each frame of the facial animation is generated based on a segment of the speech feature subsequence, lip movements in the facial animation can be close to lip movements in a real liaison situation, which allows the generated animation to be more precise and natural.

This embodiment of the present disclosure may be combined with various optional solutions in the animation generation method provided in the above embodiments. The animation generation method provided in this embodiment is described in detail for the generation process of at least one speech feature sequence. By extracting the speech feature sequence based on various feature extraction manners, the generation accuracy of the target blendshape parameters can be improved, thereby enhancing the animation presentation effect. By performing forward-backward feature completion on the speech feature sequence, it is possible to generate corresponding target blendshape parameters for each speech feature. In addition, this embodiment further provides a detailed description of the generation process of the target blendshape parameters. By generating a third blendshape parameter sequence and weighting the parameters in the third blendshape parameter sequence to obtain the target blendshape parameters, the accuracy of the target blendshape parameters can be further improved.

In some optional implementations, a generation process of at least one speech feature subsequence may include: extracting a speech feature sequence of the speech data, and extracting at least one speech feature subsequence from the speech feature sequence based on a sliding window. Before extracting the speech feature subsequences based on a sliding window, it is also possible to perform forward-backward feature completion on the speech feature sequence. Then, at least one speech feature subsequence may be extracted from the speech feature sequence with feature completion based on a sliding window.

The process of performing forward-backward feature completion may, for example, include: for a first speech feature in the speech feature sequence that has no preceding speech feature, performing speech feature completion in front of the first speech feature by copying the first speech feature; and for a last speech feature that has no following speech feature, performing speech feature completion behind the last speech feature by copying the last speech feature. Numbers of features in the speech feature sequence that require for forward-backward feature completion may be determined based on a preset size of the sliding window.

For example, the preset size of the sliding window may be 11, with the middle (i.e., the 6th) speech feature being a current speech feature. The numbers of features preceding and succeeding the current speech feature may be the same, and are both 5. In this case, the numbers of features in the speech feature sequence that require for forward-backward feature completion may be both 5.

In these optional implementations, by completing the speech feature sequence and performing sliding window segmentation, groups of speech feature sequences centered around each speech feature can be obtained, which lays the foundation for generating blendshape parameters corresponding to each speech feature.

In some optional implementations, the extracting a speech feature sequence of speech data may include: extracting speech feature sequences of the speech data by using at least two feature extraction algorithms; and determining a final speech feature sequence of the speech data based on the extracted at least two speech feature sequences. The at least two feature extraction algorithms may include an existing audio feature extraction algorithm. In these optional implementations, obtaining the final speech feature sequence of the speech data based on a plurality of speech feature sequences can improve the accuracy of the generated animation.

In some optional implementations, a generation process of at least one target blendshape parameter may include: generating, by using the preset decoder, a third blendshape parameter sequence corresponding to the at least one control condition based on the at least one control condition and the at least one preset variable; and weighting the parameters in at least one third blendshape parameter sequence to determine the at least one target blendshape parameter, where a weight of a parameter at a middle position of the third blendshape parameter sequence is greater than weights of parameters at positions on both sides of the third blendshape parameter sequence.

Considering the impact of liaison on blendshape parameters as described above, a length of the speech feature subsequence may be greater than a length of the third blendshape parameter sequence. The blendshape parameter at the middle position of the third blendshape parameter sequence may be considered as the blendshape parameter corresponding to the current speech feature. Therefore, the weight of the parameter at the middle position of the third blendshape parameter sequence may be set to be greater than the weights of the parameters at the positions on both sides of the third blendshape parameter sequence. The weight values of the blendshape parameters in the third blendshape parameter sequence may be set based on empirical values or experimental values.

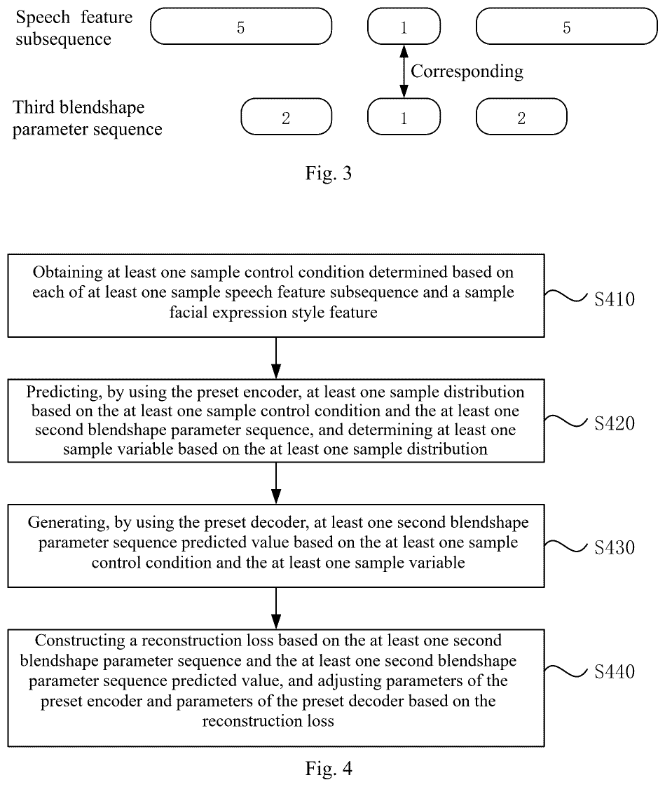

For example, FIG. 3 is a schematic diagram of a speech feature subsequence and a third blendshape parameter sequence in an animation generation method according to an embodiment of the present disclosure. Referring to FIG. 3, the speech feature subsequence may include 11 frames, namely the speech features of the preceding five frames, the speech feature of the current frame, and the speech features of the following five frames. The output third blendshape parameter sequence may include five frames, that is, the blendshape parameters of the preceding two frames, the blendshape parameter of the current frame, and the blendshape parameters of the following two frames. The weights of the blendshape parameters may be preset as [0.01, 0.09, 0.8, 0.09, 0.01] according to their positions in the third blendshape parameter sequence.

In these optional implementations, by outputting the third blendshape parameter sequence and by setting larger weights for parameters in the sequence that have a strong correlation with the current speech feature, and smaller weights for parameters that have a weaker correlation with the current speech feature, and then performing weighted summation on the parameters based on the weights to obtain the target blendshape parameter corresponding to the current speech feature, the accuracy of the target blendshape parameter can be further improved, and the presentation effect of the generated animation can be enhanced.

The technical solution of this embodiment of the present disclosure provides a detailed description of the generation process of the at least one speech feature sequence. By extracting the speech feature sequence based on various feature extraction manners, the generation accuracy of the target blendshape parameters can be improved, thereby enhancing the animation presentation effect. By performing forward-backward feature completion on the speech feature sequence, it is possible to generate corresponding target blendshape parameters for each speech feature. In addition, this embodiment further provides a detailed description of the generation process of the target blendshape parameters. By generating the third blendshape parameter sequence and weighting the parameters in the third blendshape parameter sequence to obtain the target blendshape parameters, the accuracy of the target blendshape parameters can be further improved.

In addition, the animation generation method provided in this embodiment of the present disclosure and the animation generation method provided in the above embodiments belong to the same concept of disclosure. For the technical details not described in detail in this embodiment, reference may be made to the above embodiments, and the same technical features have the same beneficial effects in this embodiment and the above embodiments.

This embodiment of the present disclosure may be combined with various optional solutions in the animation generation method provided in the above embodiments. The animation generation method provided in this embodiment provides a detailed description of the construction process of the preset generation model. By constructing the reconstruction loss of the at least one second blendshape parameter sequence, the preset generation model has the capabilities to predict variables in the latent space based on various control conditions and the at least one second blendshape parameter sequence, and the capabilities to reconstruct at least one second blendshape parameter sequence based on the control conditions and the predicted variables.

FIG. 4 is a schematic flowchart of constructing a preset generation model in an animation generation method according to an embodiment of the present disclosure. As shown in FIG. 4, according to the animation generation method provided in this embodiment, the preset generation model further includes a preset encoder. Accordingly, a construction process of the preset generation model may include:

S410: Obtaining at least one sample control condition determined based on each of at least one sample speech feature subsequence and a sample facial expression style feature.

In this embodiment, the at least one sample speech feature subsequence is obtained by extracting a sample speech feature sequence of sample speech data based on a sliding window, the sample facial expression style feature is obtained by performing feature extraction on a fourth blendshape parameter sequence, and the fourth blendshape parameter sequence is unrelated to semantics of the sample speech data. The generation manners of the sample speech feature subsequence, the sample facial expression style feature, and the sample control conditions may refer to the generation manners of the speech feature subsequence, the facial expression style feature, and the control conditions, respectively, and details are not described herein again.

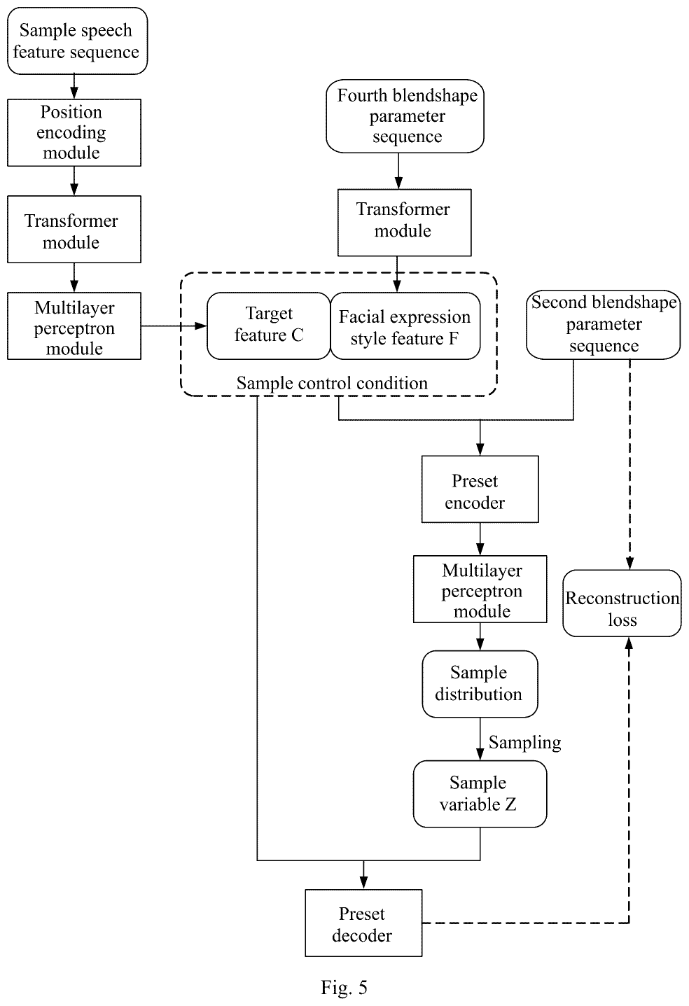

For example, FIG. 5 is a schematic block diagram of a data flow of constructing a preset generation model in an animation generation method according to an embodiment of the present disclosure. Referring to FIG. 5, the sample speech feature subsequence may be processed through a position encoding module, a transformer module, and a multilayer perceptron (MLP) module to process the sample speech feature subsequence into a target feature sequence C with preset dimensions and sizes. Moreover, a facial expression style feature F may be obtained by performing feature extraction on the fourth blendshape parameter sequence through the transformer module. The sample control condition corresponding to the sample speech feature subsequence may be obtained by concatenating C and F.

S420: Predicting, by using the preset encoder, at least one sample distribution based on the at least one sample control condition and the at least one second blendshape parameter sequence, and determining at least one sample variable based on the at least one sample distribution.

In this embodiment, since the at least one sample control condition corresponds to the at least one sample speech feature subsequence respectively, the at least one sample speech feature subsequence corresponds to at least one segment of sample speech data, and the at least one second blendshape parameter sequence is related to the semantics of the sample speech data, there is a correspondence between the at least one sample control condition and the at least one second blendshape parameter sequence. The preset encoder may be used to predict the corresponding sample distribution based on the at least one sample control condition and the corresponding second blendshape parameter sequence. The sample distribution may be understood as the distribution of sample variables that belong to the latent space.

Referring again to FIG. 5, the preset encoder may include, but is not limited to, a bi-direction gate recurrent unit module. The sample control condition and the corresponding second blendshape parameter sequence may be input into the preset encoder, and an output of the preset encoder is passed through an MLP module to obtain the corresponding sample distribution mu and logvar. The two vectors, mu and logvar, may be considered as two parameters used to represent a data space that satisfies a preset distribution. For example, when the data space distribution satisfies a normal distribution, mu and logvar may be considered as a mean and a variance, respectively. By sampling the data space that satisfies the sample distribution of mu and logvar, a sample variable Z can be obtained. The sample variable Z may be considered as a random vector Z.

S430: Generating, by using the preset decoder, at least one second blendshape parameter sequence predicted value based on the at least one sample control condition and the at least one sample variable.

In this embodiment, the sample variable input into the preset decoder is generated based on the sample control condition that is also input into the preset decoder, meaning that the sample control condition and the sample variable simultaneously input into the preset decoder have a correspondence. It may be considered that the sample control condition, in addition to being able to predict the sample variable in combination with the corresponding second blendshape parameter sequence, may also be used to reconstruct the second blendshape parameter sequence in combination with the predicted sample variable to obtain the second blendshape parameter sequence predicted value.

Referring to FIG. 5, the preset decoder may also include, but is not limited to, a bi-direction gate recurrent unit module. The sample control condition and the corresponding sample variable may be input into the preset decoder, so that the preset decoder outputs the second blendshape parameter sequence predicted value.

S440: Constructing a reconstruction loss based on the at least one second blendshape parameter sequence and the at least one second blendshape parameter sequence predicted value, and adjusting parameters of the preset encoder and parameters of the preset decoder based on the reconstruction loss.

The reconstruction loss between the second blendshape parameter sequence and the corresponding second blendshape parameter sequence predicted value may be determined based on a loss function of an existing parameter sequence. For example, a mean absolute error loss (which may be referred to as L1 loss) may be constructed based on the following formula to serve as the reconstruction loss: L=ΣW|Y−Ŷ|; where Y may represent the second blendshape parameter sequence, Ŷ may represent the second blendshape parameter sequence predicted value, W may represent the corresponding loss construction weight, and the loss construction weight for the predicted value at the middle position of the sequence is greater than the loss construction weights for the predicted values at positions on both sides of the sequence. For example, assuming that the sequence has five frames, and parameters in the sequence are 51-dimensional, Y∈R^{5,51}, the loss construction weights W may be preset as [1, 3, 5, 3, 1] according to their positions in the sequence.

In this embodiment, the reconstruction loss may be backpropagated to adjust the parameters of the preset encoder and the parameters of the preset decoder, thereby achieving the construction of the preset generation model. An existing optimizer may be used to perform iterative optimization, with a learning rate, a training batch size, and a number of training times set based on the actual application scenario.

In addition, in some optional implementations, a process of constructing the preset generation model may further include: constructing a distribution loss based on at least one sample distribution, and adjusting parameters of the preset encoder and parameters of the preset decoder based on the distribution loss.

In these optional implementations, when the at least one sample distribution meets the preset distribution, the predicted values can have higher robustness. In order to ensure that the at least one sample distribution meets the preset distribution, for example, a divergence error may be constructed based on the following formula to serve as the distribution loss: KLD(mu, log var)=−0.5Σ(1+log var−mu²−exp(log var)); where the two vectors, mu and logvar, may be considered as two parameters used to represent a data space that satisfies a preset distribution. Accordingly, a weighted sum of the reconstruction loss and the distribution loss may be used as a total loss for constructing the preset generation model. The total loss may, for example, be:

$$L = \sum W \vert Y - \hat{Y} \vert + KLD ( mu , log var ) .$$

The technical solution of this embodiment of the present disclosure provides a detailed description of the construction process of the preset generation model. By constructing the reconstruction loss of the at least one second blendshape parameter sequence, the preset generation model has the capabilities to predict variables in the latent space based on various control conditions and the at least one second blendshape parameter sequence, and the capabilities to reconstruct at least one second blendshape parameter sequence based on the control conditions and the predicted variables. The animation generation method provided in this embodiment of the present disclosure and the animation generation method provided in the above embodiments belong to the same concept of disclosure. For the technical details not described in detail in this embodiment, reference may be made to the above embodiments, and the same technical features have the same beneficial effects in this embodiment and the above embodiments.

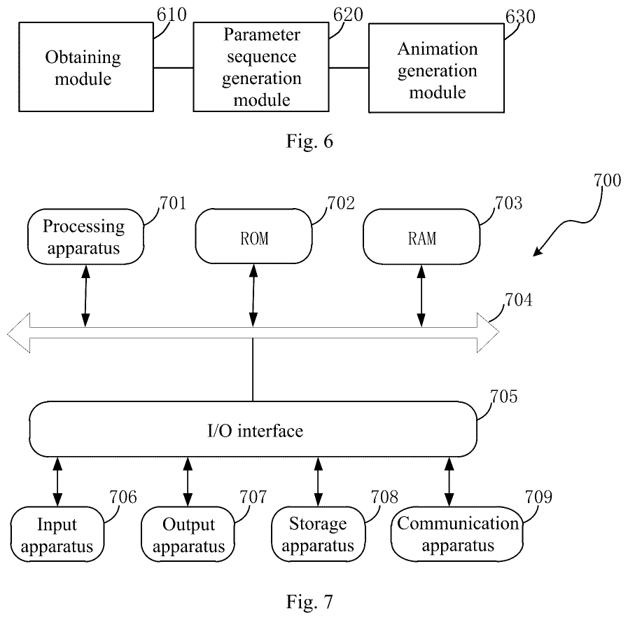

FIG. 6 is a schematic diagram of a structure of an animation generation apparatus according to an embodiment of the present disclosure. The animation generation apparatus provided in this embodiment is applicable to scenarios where a lip sync animation corresponding to speech data is generated.

As shown in FIG. 6, the animation generation apparatus provided in this embodiment of the present disclosure may include:
an obtaining module 610, configured to obtain at least one control condition determined based on each of at least one speech feature subsequence and a facial expression style feature, where the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
a parameter sequence generation module 620, configured to generate, by using a preset decoder, a target blendshape parameter corresponding to the at least one speech feature subsequence based on the at least one control condition and at least one preset variable, where the preset decoder is included in a preset generation model, the preset generation model is constructed based on at least one sample control condition and at least one second blendshape parameter sequence, and the at least one second blendshape parameter sequence is related to semantics of sample speech data corresponding to the at least one sample control condition; and
an animation generation module 630, configured to deform an object model based on at least one target blendshape parameter in sequence to generate a facial animation corresponding to the speech data.

In some optional implementations, the animation generation apparatus may further include:
a control condition determination module configured to determine at least one control condition based on the following process:
processing, by using a preset processing algorithm, the at least one speech feature subsequence into a target feature sequence with a preset dimension and a preset size; and
concatenating the at least one target feature sequence with the facial expression style feature, respectively, to obtain the at least one control condition.

In some optional implementations, the animation generation apparatus may further include:
a preset variable determination module configured to determine at least one preset variable based on the following process:
performing at least one sampling process in a latent space constructed by a preset encoder to obtain at least one preset variable, where the preset encoder is included in the preset generation model.

In some optional implementations, the parameter sequence generation module may be configured to:
generate, by using the preset decoder, a third blendshape parameter sequence corresponding to the at least one control condition based on the at least one control condition and the at least one preset variable; and
weight parameters in at least one third blendshape parameter sequence to determine the at least one target blendshape parameter, where a weight of a parameter at a middle position of the third blendshape parameter sequence is greater than weights of parameters at positions on both sides of the third blendshape parameter sequence.

In some optional implementations, the preset generation model further includes a preset encoder; accordingly, the animation generation apparatus may further include:
a model training module, configured to construct the preset generation model based on the following process:
obtaining at least one sample control condition determined based on each of at least one sample speech feature subsequence and a sample facial expression style feature, where the at least one sample speech feature subsequence is obtained by extracting a sample speech feature sequence of sample speech data based on a sliding window, the sample facial expression style feature is obtained by performing feature extraction on a fourth blendshape parameter sequence, and the fourth blendshape parameter sequence is unrelated to semantics of the sample speech data;
predicting, by using the preset encoder, at least one sample distribution based on the at least one sample control condition and the at least one second blendshape parameter sequence, and determining at least one sample variable based on the at least one sample distribution;
generating, by using the preset decoder, at least one second blendshape parameter sequence predicted value based on the at least one sample control condition and the at least one sample variable; and
constructing a reconstruction loss based on the at least one second blendshape parameter sequence and the at least one second blendshape parameter sequence predicted value, and adjusting parameters of the preset encoder and parameters of the preset decoder based on the reconstruction loss.

In some optional implementations, the model training module may be further configured to:
construct a distribution loss based on the at least one sample distribution, and adjust the parameters of the preset encoder and parameters of the preset decoder based on the distribution loss.

In some optional implementations, the object model includes at least one of the following: a two-dimensional object model and a three-dimensional object model.

The animation generation apparatus provided in this embodiment of the present disclosure can perform the animation generation method provided in any embodiment of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

Reference is made to FIG. 7 below, which is a schematic diagram of a structure of an electronic device (such as a terminal device or a server in FIG. 7) 700 suitable for implementing the embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit, a graphics processing unit, etc.) 701 that may perform a variety of appropriate actions and processing in accordance with a program stored in a read-only memory (ROM) 702 or a program loaded from a storage apparatus 708 into a random-access memory (RAM) 703. The RAM 703 further stores various programs and data required for the operation of the electronic device 700. The processing apparatus 701, the ROM 702, and the RAM 703 are connected to one another through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the animation generation method of the embodiment of the present disclosure are performed.

The electronic device provided in this embodiment of the present disclosure and the animation generation methods provided in the above embodiments belong to the same concept of disclosure. For the technical details not described in detail in this embodiment, reference may be made to the above embodiments, and this embodiment and the above embodiments have the same beneficial effects.

An embodiment of the present disclosure provides a non-transitory computer-readable storage medium storing a computer program thereon, where when the program is executed by a processor, the animation generation method according to the above embodiments is implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electric connection with one or more wires, a portable computer disk, a hard disk, a random access memory (RAM), a read only memory (ROM), an erasable programmable read-only memory (EPROM) or a flash memory (FLASH), an optical fiber, a portable compact disc read only memory (CD-ROM), an optical storage device, a magnetic storage device, or any appropriate combination of the above. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
obtain at least one control condition determined based on each of at least one speech feature subsequence and a facial expression style feature, where the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data; generate, by using a preset decoder, a target blendshape parameter corresponding to the at least one speech feature subsequence based on at least one control condition and at least one preset variable, where the preset decoder is included in a preset generation model, the preset generation model is constructed based on at least one sample control condition and at least one second blendshape parameter sequence, and the at least one second blendshape parameter sequence is related to semantics of sample speech data corresponding to the at least one sample control condition; and deform an object model based on at least one target blendshape parameter in sequence to generate a facial animation corresponding to speech data.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The names of the units and the modules do not constitute a limitation on the units and the modules themselves under certain circumstances.

The functions described herein above may be performed at least partially by one or more hardware logic components. For example, without limitation, exemplary types of hardware logic components that may be used include: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, an animation generation method is provided. The method includes:
obtaining at least one control condition determined based on each of at least one speech feature subsequence and a facial expression style feature, where the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
generating, by using a preset decoder, a target blendshape parameter corresponding to the at least one speech feature subsequence based on the at least one control condition and at least one preset variable, where the preset decoder is included in a preset generation model, the preset generation model is constructed based on at least one sample control condition and at least one second blendshape parameter sequence, and the at least one second blendshape parameter sequence is related to semantics of sample speech data corresponding to the at least one sample control condition; and
deforming an object model based on at least one target blendshape parameter in sequence to generate a facial animation corresponding to the speech data.

According to one or more embodiments of the present disclosure, an animation generation method is provided. The method further includes the following:

In some optional implementations, a determination process of the at least one control condition includes:
processing, by using a preset processing algorithm, the at least one speech feature subsequence into a target feature sequence with a preset dimension and a preset size; and
concatenating at least one target feature sequence with the facial expression style feature, respectively, to obtain the at least one control condition.

According to one or more embodiments of the present disclosure, an animation generation method is provided. The method further includes the following:

In some optional implementations, a determination process of the at least one preset variable includes:
performing at least one sampling process in a latent space constructed by a preset encoder to obtain the at least one preset variable, where the preset encoder is included in the preset generation model.

According to one or more embodiments of the present disclosure, an animation generation method is provided. The method further includes the following:

In some optional implementations, a generation process of at least one target blendshape parameter includes:
generating, by using the preset decoder, a third blendshape parameter sequence corresponding to the at least one control condition based on the at least one control condition and the at least one preset variable; and
weighting parameters in at least one third blendshape parameter sequence to determine the at least one target blendshape parameter, where a weight of a parameter at a middle position of the third blendshape parameter sequence is greater than weights of parameters at positions on both sides of the third blendshape parameter sequence.

According to one or more embodiments of the present disclosure, an animation generation method is provided. The method further includes the following:

In some optional implementations, the preset generation model further includes a preset encoder; accordingly, a construction process of the preset generation model includes:
obtaining at least one sample control condition determined based on each of at least one sample speech feature subsequence and a sample facial expression style feature, where the at least one sample speech feature subsequence is obtained by extracting a sample speech feature sequence of sample speech data based on a sliding window, the sample facial expression style feature is obtained by performing feature extraction on a fourth blendshape parameter sequence, and the fourth blendshape parameter sequence is unrelated to semantics of the sample speech data;
predicting, by using the preset encoder, at least one sample distribution based on the at least one sample control condition and the at least one second blendshape parameter sequence, and determining at least one sample variable based on the at least one sample distribution;
generating, by using the preset decoder, at least one second blendshape parameter sequence predicted value based on the at least one sample control condition and the at least one sample variable; and
constructing a reconstruction loss based on the at least one second blendshape parameter sequence and the at least one second blendshape parameter sequence predicted value, and adjusting parameters of the preset encoder and parameters of the preset decoder based on the reconstruction loss.

According to one or more embodiments of the present disclosure, an animation generation method is provided. The method further includes the following:

In some optional implementations, the distribution loss is constructed based on the at least one sample distribution, and the parameters of the preset encoder and parameters of the preset decoder are adjusted based on the distribution loss.

According to one or more embodiments of the present disclosure, an animation generation method is provided. The method further includes the following:

In some optional implementations, the object model includes at least one of the following: a two-dimensional object model and a three-dimensional object model.

According to one or more embodiments of the present disclosure, an animation generation apparatus is provided. The apparatus includes:
an obtaining module, configured to obtain at least one control condition determined based on each of at least one speech feature subsequence and a facial expression style feature, where the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
a parameter sequence generation module, configured to generate, by using a preset decoder, a target blendshape parameter corresponding to the at least one speech feature subsequence based on the at least one control condition and at least one preset variable, where the preset decoder is included in a preset generation model, the preset generation model is constructed based on at least one sample control condition and at least one second blendshape parameter sequence, and the at least one second blendshape parameter sequence is related to semantics of sample speech data corresponding to the at least one sample control condition; and
an animation generation module, configured to deform an object model based on at least one target blendshape parameter in sequence to generate a facial animation corresponding to the speech data.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An animation generation method, comprising:
obtaining at least one control condition determined based on each of at least one speech feature subsequence and a facial expression style feature, wherein the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
generating, by using a preset decoder, a target blendshape parameter corresponding to the at least one speech feature subsequence based on the at least one control condition and at least one preset variable, wherein the preset decoder is comprised in a preset generation model, the preset generation model is constructed based on at least one sample control condition and at least one second blendshape parameter sequence, and the at least one second blendshape parameter sequence is related to semantics of sample speech data corresponding to the at least one sample control condition; and
deforming an object model based on at least one target blendshape parameter in sequence to generate a facial animation corresponding to the speech data.

2. The method according to claim 1, wherein a determination process of the at least one control condition comprises:
processing, by using a preset processing algorithm, the at least one speech feature subsequence into a target feature sequence with a preset dimension and a preset size; and
concatenating at least one target feature sequence with the facial expression style feature, respectively, to obtain the at least one control condition.

3. The method according to claim 1, wherein a determination process of the at least one preset variable comprises:
performing at least one sampling process in a latent space constructed by a preset encoder to obtain the at least one preset variable, wherein the preset encoder is comprised in the preset generation model.

4. The method according to claim 1, wherein a generation process of the at least one target blendshape parameter comprises:
generating, by using the preset decoder, a third blendshape parameter sequence corresponding to the at least one control condition based on the at least one control condition and the at least one preset variable; and
weighting a parameter in at least one third blendshape parameter sequence to determine the at least one target blendshape parameter, wherein a weight of a parameter at a middle position of the third blendshape parameter sequence is greater than weights of parameters at positions on both sides of the third blendshape parameter sequence.

5. The method according to claim 1, wherein the preset generation model further comprises a preset encoder; and a construction process of the preset generation model comprises:
obtaining at least one sample control condition determined based on each of at least one sample speech feature subsequence and a sample facial expression style feature, wherein the at least one sample speech feature subsequence is obtained by extracting a sample speech feature sequence of sample speech data based on a sliding window, the sample facial expression style feature is obtained by performing feature extraction on a fourth blendshape parameter sequence, and the fourth blendshape parameter sequence is unrelated to semantics of the sample speech data;
predicting, by using the preset encoder, at least one sample distribution based on the at least one sample control condition and the at least one second blendshape parameter sequence, and determining at least one sample variable based on the at least one sample distribution;
generating, by using the preset decoder, at least one second blendshape parameter sequence predicted value based on the at least one sample control condition and the at least one sample variable; and
constructing a reconstruction loss based on the at least one second blendshape parameter sequence and the at least one second blendshape parameter sequence predicted value, and adjusting a parameter of the preset encoder and a parameter of the preset decoder based on the reconstruction loss.

6. The method according to claim 5, further comprising:
constructing a distribution loss based on the at least one sample distribution, and adjusting the parameter of the preset encoder and the parameter of the preset decoder based on the distribution loss.

7. The method according to claim 1, wherein the object model comprises at least one of the following: a two-dimensional object model and a three-dimensional object model.

8. An electronic device, comprising:
one or more processors; and
a storage apparatus configured to store one or more programs,
wherein the one or more programs, when executed by the one or more processors, cause the one or more processors to implement an animation generation method, comprising:
obtaining at least one control condition determined based on each of at least one speech feature subsequence and a facial expression style feature, wherein the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
generating, by using a preset decoder, a target blendshape parameter corresponding to the at least one speech feature subsequence based on the at least one control condition and at least one preset variable, wherein the preset decoder is comprised in a preset generation model, the preset generation model is constructed based on at least one sample control condition and at least one second blendshape parameter sequence, and the at least one second blendshape parameter sequence is related to semantics of sample speech data corresponding to the at least one sample control condition; and
deforming an object model based on at least one target blendshape parameter in sequence to generate a facial animation corresponding to the speech data.

9. The electronic device according to claim 8, wherein in the animation generation method,
a determination process of the at least one control condition comprises:
processing, by using a preset processing algorithm, the at least one speech feature subsequence into a target feature sequence with a preset dimension and a preset size; and
concatenating at least one target feature sequence with the facial expression style feature, respectively, to obtain the at least one control condition.

10. The electronic device according to claim 8, wherein in the animation generation method,
a determination process of the at least one preset variable comprises:
performing at least one sampling process in a latent space constructed by a preset encoder to obtain the at least one preset variable, wherein the preset encoder is comprised in the preset generation model.

11. The electronic device according to claim 8, wherein in the animation generation method,
a generation process of the at least one target blendshape parameter comprises:
generating, by using the preset decoder, a third blendshape parameter sequence corresponding to the at least one control condition based on the at least one control condition and the at least one preset variable; and
weighting a parameter in at least one third blendshape parameter sequence to determine the at least one target blendshape parameter, wherein a weight of a parameter at a middle position of the third blendshape parameter sequence is greater than weights of parameters at positions on both sides of the third blendshape parameter sequence.

12. The electronic device according to claim 8, wherein in the animation generation method,
the preset generation model further comprises a preset encoder; and a construction process of the preset generation model comprises:
obtaining at least one sample control condition determined based on each of at least one sample speech feature subsequence and a sample facial expression style feature, wherein the at least one sample speech feature subsequence is obtained by extracting a sample speech feature sequence of sample speech data based on a sliding window, the sample facial expression style feature is obtained by performing feature extraction on a fourth blendshape parameter sequence, and the fourth blendshape parameter sequence is unrelated to semantics of the sample speech data;
predicting, by using the preset encoder, at least one sample distribution based on the at least one sample control condition and the at least one second blendshape parameter sequence, and determining at least one sample variable based on the at least one sample distribution;
generating, by using the preset decoder, at least one second blendshape parameter sequence predicted value based on the at least one sample control condition and the at least one sample variable; and
constructing a reconstruction loss based on the at least one second blendshape parameter sequence and the at least one second blendshape parameter sequence predicted value, and adjusting a parameter of the preset encoder and a parameter of the preset decoder based on the reconstruction loss.

13. The electronic device according to claim 12, wherein the animation generation method further comprises:
constructing a distribution loss based on the at least one sample distribution, and adjusting the parameter of the preset encoder and the parameter of the preset decoder based on the distribution loss.

14. The electronic device according to claim 8, wherein in the animation generation method,
the object model comprises at least one of the following: a two-dimensional object model and a three-dimensional object model.

15. A non-transitory computer-readable storage medium comprising computer-executable instructions, wherein the computer-executable instructions, when executed by a computer processor, are configured to cause the computer processor to perform an animation generation method, comprising:
obtaining at least one control condition determined based on each of at least one speech feature subsequence and a facial expression style feature, wherein the at least one speech feature subsequence is obtained by extracting a speech feature sequence of speech data based on a sliding window, the facial expression style feature is obtained by performing feature extraction on a first blendshape parameter sequence, and the first blendshape parameter sequence is unrelated to semantics of the speech data;
generating, by using a preset decoder, a target blendshape parameter corresponding to the at least one speech feature subsequence based on the at least one control condition and at least one preset variable, wherein the preset decoder is comprised in a preset generation model, the preset generation model is constructed based on at least one sample control condition and at least one second blendshape parameter sequence, and the at least one second blendshape parameter sequence is related to semantics of sample speech data corresponding to the at least one sample control condition; and
deforming an object model based on at least one target blendshape parameter in sequence to generate a facial animation corresponding to the speech data.

16. The non-transitory computer-readable storage medium according to claim 15, wherein in the animation generation method,
a determination process of the at least one control condition comprises:
processing, by using a preset processing algorithm, the at least one speech feature subsequence into a target feature sequence with a preset dimension and a preset size; and
concatenating at least one target feature sequence with the facial expression style feature, respectively, to obtain the at least one control condition.

17. The non-transitory computer-readable storage medium according to claim 15, wherein in the animation generation method,
a determination process of the at least one preset variable comprises:
performing at least one sampling process in a latent space constructed by a preset encoder to obtain the at least one preset variable, wherein the preset encoder is comprised in the preset generation model.

18. The non-transitory computer-readable storage medium according to claim 15, wherein in the animation generation method,
a generation process of the at least one target blendshape parameter comprises:
generating, by using the preset decoder, a third blendshape parameter sequence corresponding to the at least one control condition based on the at least one control condition and the at least one preset variable; and
weighting a parameter in at least one third blendshape parameter sequence to determine the at least one target blendshape parameter, wherein a weight of a parameter at a middle position of the third blendshape parameter sequence is greater than weights of parameters at positions on both sides of the third blendshape parameter sequence.

19. The non-transitory computer-readable storage medium according to claim 15, wherein in the animation generation method,
the preset generation model further comprises a preset encoder; and a construction process of the preset generation model comprises:
obtaining at least one sample control condition determined based on each of at least one sample speech feature subsequence and a sample facial expression style feature, wherein the at least one sample speech feature subsequence is obtained by extracting a sample speech feature sequence of sample speech data based on a sliding window, the sample facial expression style feature is obtained by performing feature extraction on a fourth blendshape parameter sequence, and the fourth blendshape parameter sequence is unrelated to semantics of the sample speech data;
predicting, by using the preset encoder, at least one sample distribution based on the at least one sample control condition and the at least one second blendshape parameter sequence, and determining at least one sample variable based on the at least one sample distribution;
generating, by using the preset decoder, at least one second blendshape parameter sequence predicted value based on the at least one sample control condition and the at least one sample variable; and
constructing a reconstruction loss based on the at least one second blendshape parameter sequence and the at least one second blendshape parameter sequence predicted value, and adjusting a parameter of the preset encoder and a parameter of the preset decoder based on the reconstruction loss.

20. The non-transitory computer-readable storage medium according to claim 19, wherein the animation generation method further comprises:
constructing a distribution loss based on the at least one sample distribution, and adjusting the parameter of the preset encoder and the parameter of the preset decoder based on the distribution loss.
